(19) United States
(12) Patent Application Publication
(10) Pub. No.: US 2015/0287077 A1
(43) Pub. Date: Oct. 8, 2015

(54) SYSTEMS AND METHODS TO PROCESS OFFERS BASED ON MERCHANT HIERARCHIES

(71) Applicant: Visa International Service Association, San Francisco, CA (US)

(72) Inventors: Ilker Celikyilmaz, Mountain View, CA (US); Joseph Spears, Hayward, CA (US); Muhammad Bassam Adil Khan, San Mateo, CA (US); Kalpana Jogi, San Francisco, CA (US); Darpan Dewan, Foster City, CA (US)

(73) Assignee: VISA INTERNATIONAL SERVICE ASSOCIATION, San Francisco, CA (US)

(21) Appl. No.: 14/312,228

(22) Filed: Jun. 23, 2014

Related U.S. Application Data
(60) Provisional application No. 61/974,359, filed on Apr. 2, 2014.

(51) Int. Cl. G06Q 30/02; G06Q 20/40

(52) U.S. Cl. CPC G06Q 30/0253; G06Q 20/405

(57) ABSTRACT

System and method configured to store data defining merchant groups, data associating transaction terminals with merchant groups, and data associating offers with merchant groups. Each of the merchant has one or more transaction terminals configured to process payments via a payment processing network. When a transaction being processed in the payment processing network is detected to be relevant to offers, the transaction data is augmented/enriched with data identifying one or more merchant groups to which a transaction terminal that initiates the transaction is associated. Offer rules are applied to the transaction data that is augmented with merchant group data.

### RELATED APPLICATIONS

The present application claims priority to U.S. Pat. App. Ser. No. 61/974,359, filed Apr. 2, 2014 and entitled “Systems and Methods to Process Offers based on Merchant Hierarchies”, the entire disclosure of which is hereby incorporated herein by reference.

The present application relates to U.S. patent application Ser. No. 12/896,632, filed Oct. 1, 2010, published as U.S. Pat. App. Pub. No. 2011/0087530, entitled “Systems and Methods to Provide Loyalty Programs,” U.S. patent application Ser. No. 13/152,186, filed Jun. 2, 2011, issued as U.S. Pat. No. 8,359,274, and entitled “Systems and Methods to Provide Messages in Real-Time with Transaction Processing,” U.S. patent application Ser. No. 13/237,457, filed Sep. 20, 2011, published as 2012/0078697, and entitled “Systems and Methods to Program Operations for Interaction with Users,” U.S. patent application Ser. No. 13/237,467, filed Sep. 20, 2011, published as 2012/0072997, and entitled “Systems and Methods to Modify Interaction Rules during Run Time,” U.S. patent application Ser. No. 13/225,185, filed Sep. 2, 2011, published as 2012/0066064, and entitled “Systems and Methods to Provide Real-Time Offers via a Cooperative Database,” the disclosures of which applications are hereby incorporated herein by reference.

### FIELD OF THE TECHNOLOGY

At least some embodiments of the present disclosure relate to configuring operations to be performed by computing apparatuses in general, and more particularly, but not limited to, configuring the processing of computing operations in relation with payment processing, such as payments made via credit cards, debit cards, prepaid cards, etc.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as a cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 shows a system to provide information based on transaction data according to one embodiment.

FIG. 3 illustrates a transaction terminal according to one embodiment.

FIG. 4 illustrates an account identifying device according to one embodiment.

FIG. 5 illustrates a data processing system according to one embodiment.

FIG. 6 shows the structure of account data for providing loyalty programs according to one embodiment.

FIG. 7 shows a system to provide real-time messages according to one embodiment.

FIG. 8 shows a method to organize offers and merchant data according to one embodiment.

FIG. 9 shows a system configured to process offers based on a merchant hierarchy according to one embodiment.

FIG. 10 shows a system configured to identify applicable offers based on a merchant hierarchy according to one embodiment.

FIG. 11 shows a system configured to communicate offers to users according to one embodiment.

FIG. 12 shows a method of applying offer rules to identify offers applicable to a payment transaction according to one embodiment.

### DETAILED DESCRIPTION

### Introduction

The transaction data, such as records of transactions made via credit accounts, debit accounts, prepaid accounts, bank accounts, stored value accounts and the like, can be processed to optionally provide information for various services, such as reporting, benchmarking, advertising, content or offer selection, customization, personalization, prioritization, offer redemption, loyalty benefit provisioning and/or redemption, etc.

In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. Some examples of targeted offer delivery are provided in U.S. Pat. No. 8,606,630, entitled “Systems and Methods to Deliver Targeted Advertisements to Audience”, the entire disclosure of which is hereby incorporated herein by reference.

For example, the computing apparatus can be configured to generate trigger records for a transaction handler to identify authorization requests that satisfy the conditions specified in the trigger records, identify communication references of the users associated with the identified authorization requests, and use the communication references to target real-time messages at the users in parallel with the transaction handler providing responses to the respective authorization requests. Details in one embodiment regarding the generation and delivery of messages in real-time with the processing of transactions are provided in the section entitled “REAL-TIME MESSAGES”, and U.S. Pat. Nos. 8,359,274 and 8,407,148, both entitled “Systems and Methods to Provide Messages in Real-Time with Transaction Processing”, the entire disclosures of which are hereby incorporated herein by reference.

For example, the computing apparatus can be programmable for real-time interaction with users to provide messages and/or offers, validate fulfillment conditions, and provide benefits to qualified users to fulfill the offers. In one embodiment, the computing apparatus is configured to be programmed via accepting definitions of independent events and linking the events via prerequisite requirements to specify qualification conditions. The linked events form a flow or network of events; and user progress in the flow or network of events is tracked. The operations for each event are performed in an atomic way to allow the user positions in the flow or network of events to be identified as being in between adjacent events in the network. As a result, the programming of the real-time interaction, including the offer rules and messages, can be easily modified during the execution of the programming. Details in one embodiment regarding the formulation and management of real-time interaction are provided in U.S. Pat. App. Pub. No. 2012/0078697, entitled “Systems and Methods to Program Operations for Interaction with Users”, the entire disclosure of which application is hereby incorporated herein by reference.

For example, the computing apparatus can be configured to use a merchant hierarchy to improve the efficiency in processing transactions that may be relevant to offers. The system allows the customized definition of a merchant group that may include one or more merchants and/or one or more store locations of the merchants in the group. Each of the merchant has one or more transaction terminals configured to process payments via a payment processing network. An offer is associated with the merchant group such that the offer is applicable to any of the merchants/store locations in the merchant group. When a transaction being processed in the payment processing network is detected to be relevant to offers, the transaction data is augmented with data identifying the merchant groups to which a transaction terminal that initiates the transaction is associated. Offer rules are applied to the transaction data that is augmented with merchant group data. Details in one embodiment regarding the use of merchant hierarchy in offer processing are provided in section entitled “MERCHANT HIERARCHY”.

For example, the computing apparatus correlates transactions with activities that occurred outside the context of the transaction, such as online advertisements presented to the customers that at least in part cause offline transactions. The correlation data can be used to demonstrate the success of the advertisements, and/or to improve intelligence information about how individual customers and/or various types or groups of customers respond to the advertisements. Examples of correlating offline transactions with online activities can be found in U.S. Pat. No. 8,626,579, entitled “Systems and Methods for Closing the Loop between Online Activities and Offline Purchases”, the entire disclosure of which is hereby incorporated herein by reference.

In one embodiment, a single entity operating the transaction handler performs various operations in the services provided based on the transaction data. For example, in the presentation of the personalized or targeted advertisements, the single entity may perform the operations such as generating the intelligence information, selecting relevant intelligence information for a given audience, selecting, identifying, adjusting, prioritizing, personalizing and/or generating advertisements based on selected relevant intelligence information, and facilitating the delivery of personalized or targeted advertisements, etc. Alternatively, the entity operating the transaction handler cooperates with one or more other entities by providing information to these entities to allow these entities to perform at least some of the operations for presentation of the personalized or targeted advertisements.

### Transaction Data Based Services

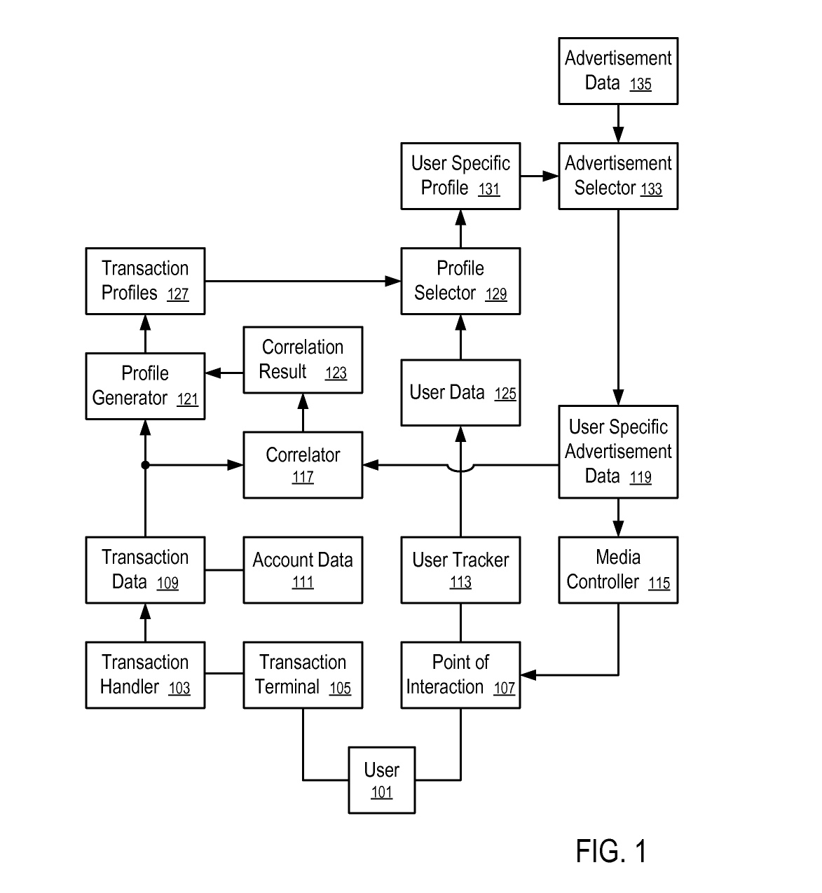

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 1, the system further includes a correlator (117) to correlate user specific advertisement data (119) with transactions resulting from the user specific advertisement data (119). The correlation results (123) can be used by the profile generator (121) to improve the transaction profiles (127).

The transaction profiles (127) of one embodiment are generated from the transaction data (109). For example, an aggregated spending profile can be generated via a factor analysis and cluster analysis to summarize the spending patterns/behaviors reflected in the transaction records, in a way as illustrated in U.S. Pat. App. Pub. No. 2010/0306032, the disclosure of which is hereby incorporated herein by reference.

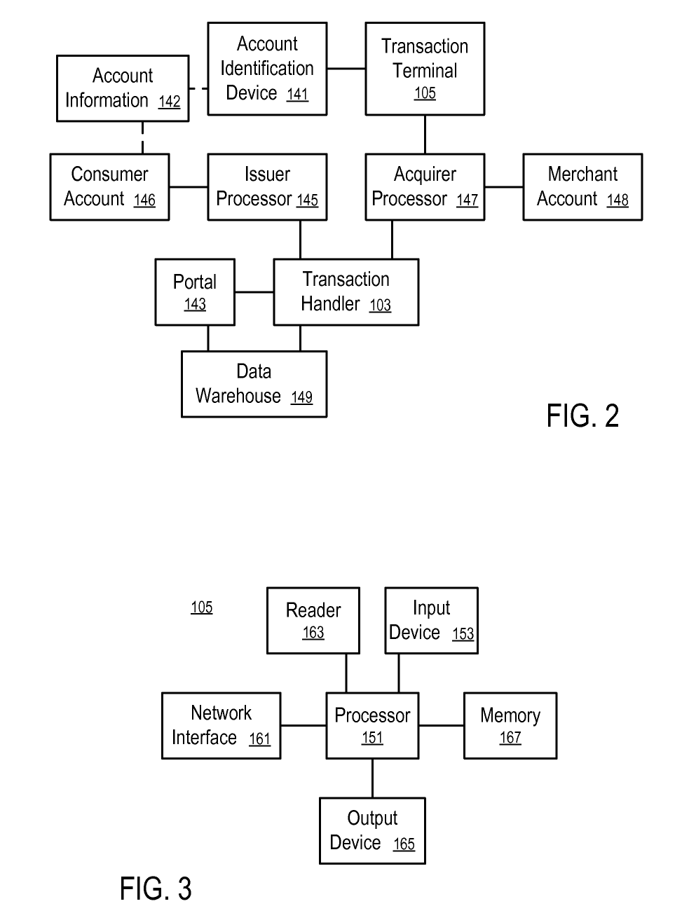

In one embodiment, a data warehouse (149) as illustrated in FIG. 2 is coupled with the transaction handler (103) to store the transaction data (109) and other data, such as account data (111), transaction profiles (127) and correlation results (123). In FIG. 2, a portal (143) is coupled with the data warehouse (149) to provide data or information derived from the transaction data (109), in response to a query request from a third party or as an alert or notification message.

In FIG. 2, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

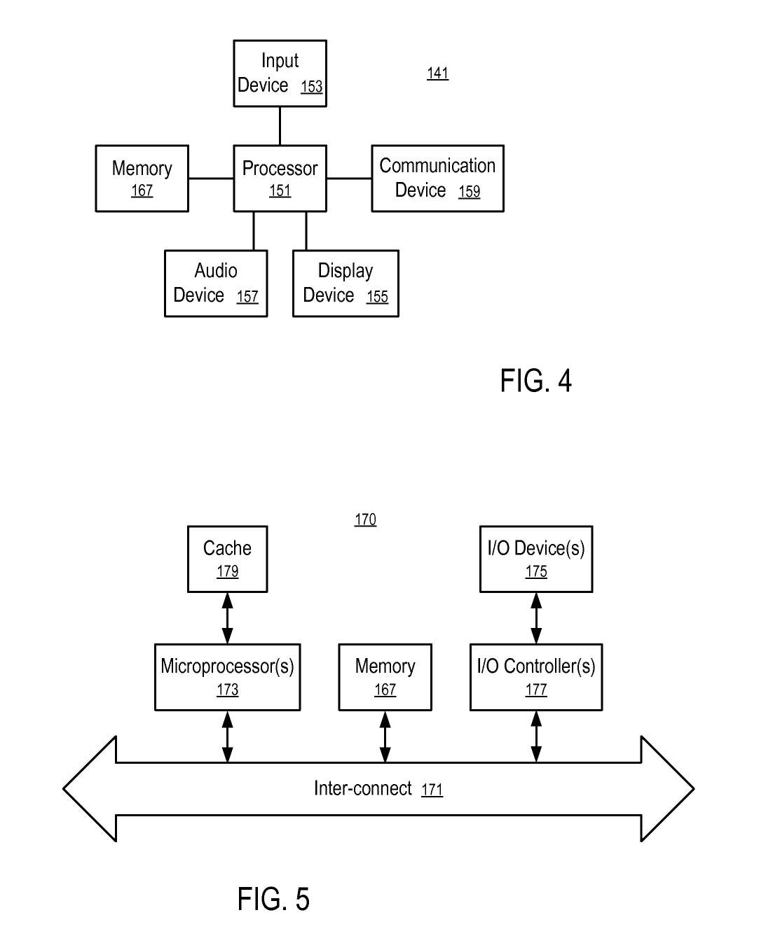

FIGS. 3 and 4 illustrate examples of transaction terminals (105) and account identification devices (141). FIG. 5 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 1-5, and other figures, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

In one embodiment, the characteristics of transaction patterns of customers are profiled via clusters, factors, and/or categories of purchases. Further details and examples in one embodiment are provided in U.S. Pat. App. Pub. No. 2010/0306032, entitled “Systems and Methods to Summarize Transaction Data”, and U.S. Pat. App. Pub. No. 2010/0306029, entitled “Cardholder Clusters”.

In one embodiment, a set of profiles are generated from the transaction data for a plurality of geographical regions, such as mutually exclusive, non-overlapping regions defined by postal codes. Transactions of account holders residing in the regions are aggregated according to merchant categories for the respective regions and subsequently normalized to obtain preference indicators that reveal the spending preferences of the account holders in the respective regions. Each of the profiles for respective regions is based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in U.S. Pat. App. Pub. No. 2013/0124263, entitled “Systems and Methods to Summarize Transaction data,” the disclosure of which is hereby incorporated herein by reference.

### Loyalty Program

In one embodiment, the transaction handler (103) uses the account data (111) to store information for third party loyalty programs.

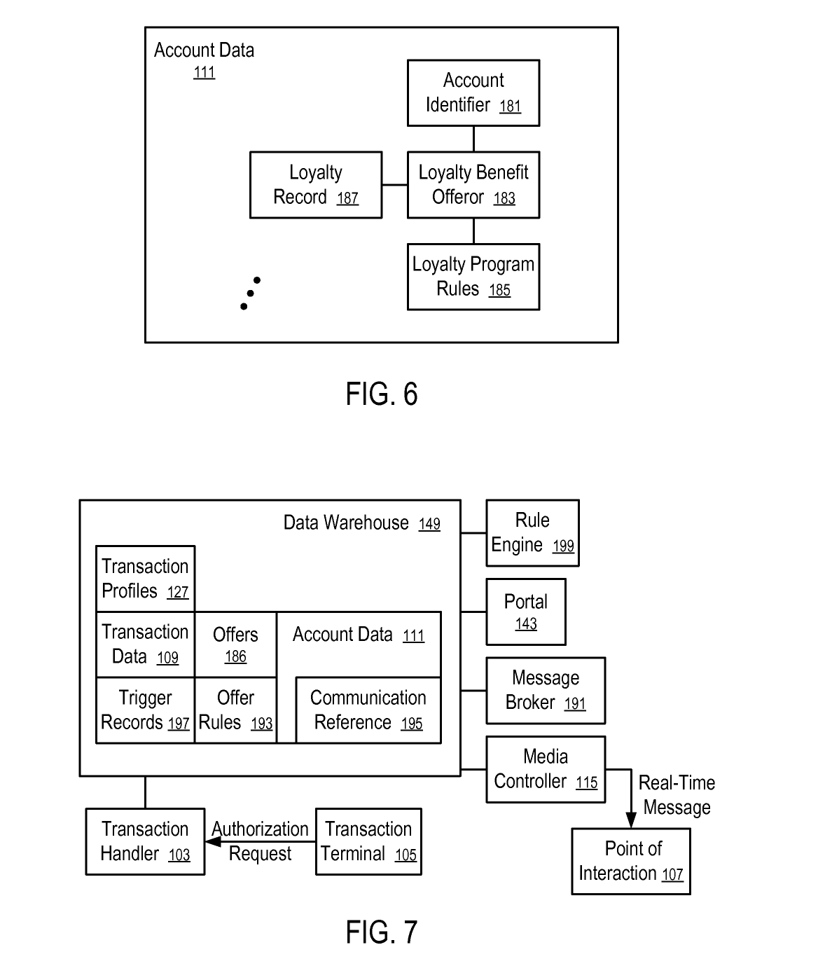

FIG. 6 shows the structure of account data (111) for providing loyalty programs according to one embodiment. In FIG. 6, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 6 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185). In one embodiment, the loyalty benefit as identified in the loyalty record (187) can be redeemed in connection with a transaction in a way the benefit of an offer stored in association with the account identifier (181) is redeemed.

Examples of loyalty programs through collaboration between collaborative constituents in a payment processing system, including the transaction handler (103) in one embodiment are provided in U.S. Pat. App. Pub. No. 2008/0059302, and entitled “Loyalty Program Service,” U.S. Pat. App. Pub. No. 2008/0059306, and entitled “Loyalty Program Incentive Determination,” and U.S. Pat. App. Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. Pat. App. Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. Pat. App. Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. Pat. App. Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. Pat. App. Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. Pat. App. Pub. No. 2009/0030793, and entitled “Multi-Vendor Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. Pat. App. Pub. No. 2010/0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. Pat. App. Pub. No. 2010/0114686, and entitled “Real-Time Statement Credits and Notifications,” the disclosure of which is hereby incorporated herein by reference.

Details on loyalty programs in one embodiment are provided in U.S. Pat. App. Pub. No. 2011/0087530, and entitled “Systems and Methods to Provide Loyalty Programs,” the disclosure of which is hereby incorporated herein by reference.

### Real-Time Messages

In one embodiment, the transaction handler (103) is configured to cooperate with the media controller (115) to facilitate real-time interaction with the user (101) when the payment of the user (101) is being processed by the transaction handler (103). The real-time interaction provides the opportunity to impact the user experience during the purchase (e.g., at the time of card swipe), through delivering messages in real-time to a point of interaction (107), such as a mobile phone, a personal digital assistant, a portable computer, etc. The real-time message can be delivered via short message service (SMS), email, instant messaging, or other communications protocols.

In one embodiment, the real-time message is provided without requiring modifications to existing systems used by the merchants and/or issuers.

FIG. 7 shows a system to provide real-time messages according to one embodiment. In FIG. 7, the transaction handler (103) (or a separate computing system coupled with the transaction handler (103)) is to detect the occurrence of certain transactions of interest during the processing of the authorization requests received from the transaction terminal (105); a message broker (191) is to identify a relevant message for the user (101) associated with the corresponding authorization request; and the media controller (115) is to provide the message to the user (101) at the point of interaction (107) via a communication channel separate from the channel used by the transaction handler (103) to respond to the corresponding authorization request submitted from the transaction terminal (105).

In one embodiment, the media controller (115) is to provide the message to the point of interaction (107) in parallel with the transaction handler (103) providing the response to the authorization request.

In one embodiment, the point of interaction (107) receives the message from the media controller (115) in real-time with the transaction handler (103) processing the authorization request. In one embodiment, the message is to arrive at the point of interaction (107) in the context of the response provided from the transaction handler (103) to the transaction terminal (105). For example, the message is to arrive at the point of interaction (107) substantially at the same time as the response to the authorization request arrives at the transaction terminal, or with a delay not long enough to cause the user (101) to have the impression that the message is in response to an action other that the payment transaction. For example, the message is to arrive at the point of interaction (107) prior to the user (101) completing the transaction and leaving the transaction terminal (105), or prior to the user (101) leaving the retail location of the merchant operating the transaction terminal (105).

In FIG. 7, the system includes a portal (143) to provide services to merchants and/or the user (101).

For example, in one embodiment, the portal (143) allows the user (101) to register the communication reference (195) in association with the account data (111), such as the account information (142) of the consumer account (146); and the media controller (115) is to use the communication reference (195) to deliver the message to the point of interaction (107). Examples of the communication reference (195) includes a mobile phone number, an email address, a user identifier of an instant messaging system, an IP address, etc.

In one embodiment, the portal (143) allows merchants and/or other parties to define rules (193) to provide offers (186) as real-time responses to authorization requests; and based on the offer rules (193), the message broker (191) is to generate, or instruct the media controller to generate, the real-time message to provide the offers (186) to the user (101). For example, the offer (186) may include a discount, an incentive, a reward, a rebate, a gift, or other benefit, which can be redeemed upon the satisfaction of certain conditions required by the offer rules (193). In one embodiment, based on the offer rules (193) the message broker (191) configures a message by selecting the appropriate message template from (an) existing message(s) template(s), and inserts any relevant data (e.g., the communication reference (195)) into the selected template, then passes the configured message to the media controller (115), which delivers the message to the point of interaction (107). In one embodiment, the message broker (191) (or a subsystem) is used to manage message templates along with the rules for selecting the appropriate message template from among several potential choices.

In one embodiment, the offer rules (193) include offer details, targeting rules, advertisement campaign details, profile mapping, creative mapping, qualification rules, award/notify/fulfillment rules, approvals, etc. Creative elements for offers include text, images, channels, approvals, etc.

In one embodiment, when the offer rules (193) are activated by the merchant or advertiser via the portal (143), the message broker (191) is to generate trigger records (197) for the transaction handler (103). The transaction handler (103) is to monitor the incoming authorization requests to identify requests that satisfy the conditions specified in the trigger records (197) during the process of the authorization requests, and to provide the information about the identified requests to the message broker (191) for the transmission of an appropriate real-time message in accordance with the offer rules (193).

In one embodiment, the generation of the trigger records (197) for the transaction handler (103) is in real-time with the merchant or advertiser activating the offer rules (193). Thus, the offer rules (193) can be activated and used for the detection of the new authorization requests in real-time, while the transaction handler (103) continues to process the incoming authorization requests.

In one embodiment, the portal (143) provides information about the spending behaviors reflected in the transaction data (109) to assist the merchants or advertisers to target offers or advertisements. For example, in one embodiment, the portal (143) allows merchants to target the offers (186) based on transaction profiles (127). For example, the offer rules (193) are partially based on the values in a transaction profile (127), such as an aggregated spending profile. In one embodiment, the offer rules (193) are partially based on the information about the last purchase of the user (101) from the merchant operating the transaction terminal (105) (or another merchant), and/or the information about the location of the user (101), such as the location determined based on the location of the transaction terminal (105) and/or the location of the merchant operating the transaction terminal (105).

In one embodiment, the portal (143) provides transaction based statistics, such as merchant benchmarking statistics, industry/market segmentation, etc., to assist merchants and advertisers to identify customers.

Thus, the real-time messages can be used to influence customer behaviors while the customers are in the purchase mode.

In one embodiment, the benefit of the offers (186) can be redeemed via the transaction handler (103). The redemption of the offer (186) may or may not require the purchase details (e.g., SKU level purchase details). Details in one embodiment about redeeming offers (186) via the transaction handler (103) are provided in U.S. Pat. App. Pub. No. 2011/0288918, and entitled “Systems and Methods for Redemption of Offers,” the disclosure of which is hereby incorporated herein by reference.

In one embodiment, when the authorization request for a purchase indicates that the purchase qualifies the offer (186) for redemption if the purchase corresponding to the authorization request is completed, the message broker (191) is to construct a message and use the media controller (115) to deliver the message in real-time with the processing of the authorization request to the point of interaction (107). The message informs the user (101) that when the purchase is completed, the transaction handler (103) and/or the issuer processor (145) is to provide the benefit of the offer (186) to the user (101) via statement credit or some other settlement value, for example points in a registered loyalty program, or credit at the point of sale using a digital coupon delivered to the purchaser via cell phone.

In one embodiment, the settlement of the payment transaction corresponding to the authorization request does not occur in real-time with the processing of the authorization request. For example, the merchant may submit the complete purchases for settlement at the end of the day, or in accordance with a predetermined schedule. The settlement may occur one or more days after the processing of the authorization request.

In one embodiment, when transactions are settled, the settled transactions are matched to the authorization requests to identify offers (186) that are redeemable in view of the settlement. When the offer (186) is confirmed to be redeemable based on a record of successful settlement, the message broker (191) is to use the media controller (115) to provide a message to the point of interaction (107) of the user (101), such as the mobile phone of the user (101). In one embodiment, the message is to inform the user (101) of the benefit to be provided as statement credits and/or to provide additional offers. In one embodiment, the message to confirm the statement credits is transmitted in real-time with the completion of the transaction settlement.

In one embodiment, the message broker (191) is to determine the identity of the merchant based on the information included in the authorization request transmitted from the transaction terminal (105) to the transaction handler (103). In one embodiment, the identity of the merchant is normalized to allow the application of the offer rules (193) that are merchant specific.

In one embodiment, the portal (143) provides operation facilities, such as onboarding, contact management, certification, file management, workflow, etc. to assist the merchants and/or advertisers to complete the tasks related to the offers (186).

In one embodiment, the portal (143) allows the user (101) to opt in or opt out of the real-time message delivery service.

### Merchant Hierarchy

In one embodiment, a system and method is configured to allow clients to define a merchant group and specify an offer for the merchant group. The merchant group may include merchants independently registered via an onboarding process in which the association of the merchant and the transaction terminals of the merchant is identified. A merchant may belong to multiple merchant groups for different offers. A single offer is generated and processed by the rule engine for the entire merchant group. When a merchant joins or leaves the offer, the system can be updated via changing the definition of the merchant group.

Thus, when a set of merchants and/or store locations of the merchant set provide offers having the same offer rules (other than the merchant identifier and/or store locations), the offers can be grouped as a single offer for the merchant group corresponding to the merchant set and/or the store locations. As a result, it is not necessary to generate separate offers for different merchants and/or store locations of the merchants. Grouping the offers for processing significantly increases the efficiency of the offer rules in applying offer rules.

In one embodiment, when a transaction of a merchant is detected, the transaction data is enriched with data identifying the merchant groups in which the respective merchant is a member. As a result, the rule engine only need to apply a single set of offer rules for the entire merchant group, instead of one set of offer rules for each merchant and/or store location in the merchant group; and thus, the efficiency of the system improved.

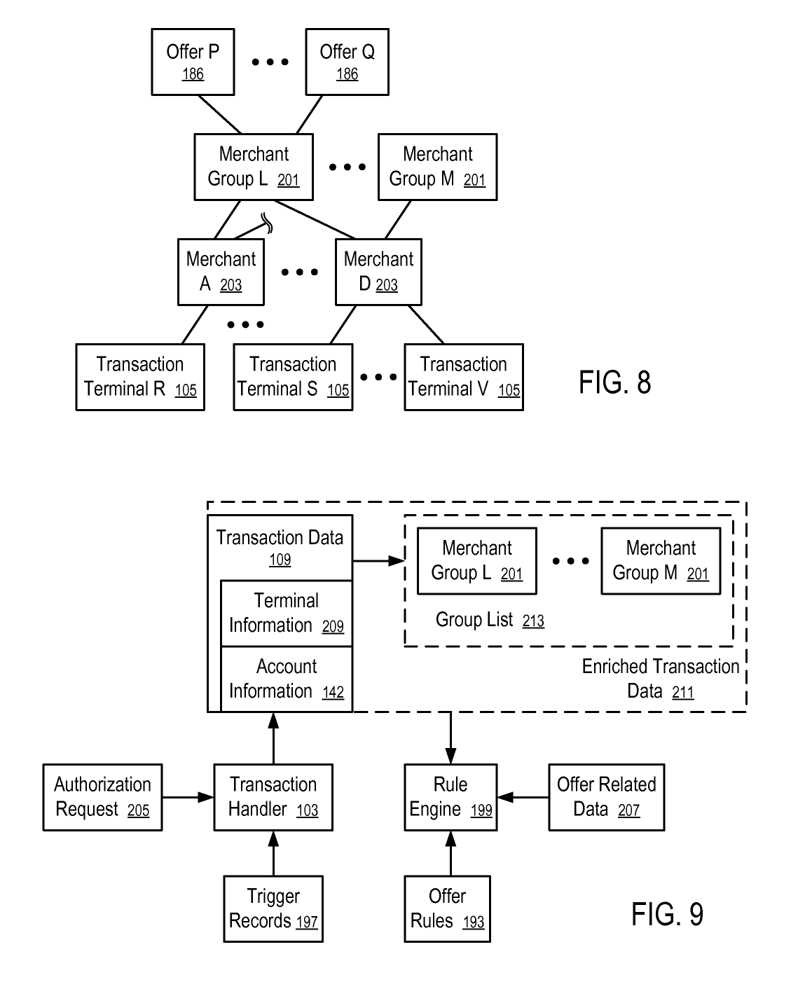

FIG. 8 shows a method to organize offers and merchant data according to one embodiment. In FIG. 8, the merchant hierarchy includes merchant groups (201), merchants (203), and transaction terminals (105).

For example, a merchant D (203) may have transaction terminals S to V (105). During a merchant onboarding processing, the transaction terminals (105) as recognized in the payment processing network are associated with the respective merchants that utilize the respective transaction terminals (105) in their stores.

During the configuration of an offer, the merchants that support the same set of offer rules are identified as being corresponding to a specific merchant group (201). Thus, instead of storing multiple offers for each of the merchants, the system creates a single offer (186) for the entire merchant group (201) and associates the offer with the merchant group (201).

In one embodiment, a merchant (203) may represent a separate store of a chain or franchise. Thus, separate stores or locations of a chain or franchise may be treated as a separate merchant (203) in FIG. 8.

Alternatively, a merchant hierarchy may further include intermediate hierarchies, such as merchants in a franchise under the same owner, merchants in the same franchise in the same region, merchants in the same franchise, etc.

In some embodiments, there may be multiple levels of merchant groups. For example, a high level merchant group (e.g., a franchise) may be defined as a plurality of low level merchant groups (e.g., stores under the same owners within the franchise).

Thus, the definition of merchant groups is not limited to the illustration shown in FIG. 8.

In one embodiment, the system is configured to detect offers from different merchants or groups having rules that are substantially the same and generate a merchant group to combine the offers from the different merchants into a single offer associated with the merchant group.

In one embodiment, when there are differences among the offers being converted into the single offer for the merchant group, the differences can be accounted for as additional rules for the combined single offer. When the cost of processing of the additional rules for the combined offer is smaller than the processing of the additional offers, the system may automatically combine the offer for improved processing efficiency. Thus, when given a set of offers from different merchants with different offer rules, the system can be configured to automatically group similar offers for suitable merchant groups and generate the combined offers for improved real time offer processing.

FIG. 9 shows a system configured to process offers based on a merchant hierarchy according to one embodiment.

In FIG. 9, a rule engine (199) is configured to apply offer rules (193) on transaction related data to determine actions to be taken for applicable offers, such as providing benefits to the transactions, adjusting the transactions, generating new transactions to settle the cost of the benefits provided in according to the applicable offers, sending messages to the users, partners, etc.

For example, in response to an authorization request (205) received in the transaction handler (103) for a payment transaction made using the account information (142) of a consumer account (146), the transaction handler (103) may pass the transaction data (109) about the payment transaction to the rule engine (199) for further processing.

In one embodiment, a trigger record (197) is used to configure to allow the transaction handler (103) to select a subset of authorization requests (205) for further offer processing. The trigger record (197) identifies a standardized subset of offer requirements that an authorization request (205) is to meet in order to be selected by the transaction handler (103) for offer processing. If the standardized subset of offer requirements is not satisfied by an authorization request, the corresponding payment transaction is not relevant to the respective offer.

In one embodiment, to improve the efficiency of the transaction handler (103) in processing the trigger records (197), trigger records (197) having similar or same requirements are combined. Thus, the number of trigger records (197) to be checked to select an authorization request (205) for offer processing can be reduced.

For example, the trigger records (197) may be configured to require the authorization requests (205) to be made via account information (142) associated with active offers (186). If the account information (142) is not associated with an active offer (186), the authorization request (205) would not be relevant to offer processing and thus need not to be selected for further processing.

Alternatively, the transaction handler (103) may be configured to forward transaction data of all incoming authorization requests (205) for offer processing, without the use of the trigger records (197). For example, the rule engine (199) may use the trigger records (197) to pre-filter the transaction data (109) from the transaction handler (103) for further offer processing.

In FIG. 9, the transaction data (109) includes the terminal information (209) and the account information (142). The terminal information (209) in the transaction data (109) identifies the transaction terminal (105) on which the payment transaction is initiated using the account information (142); and the account information (142) identifies the consumer account (142) in which the payment transaction is made.

In FIG. 9, based on the merchant hierarchy (e.g., as illustrated in FIG. 8), a list (213) of merchant groups (201) is identified. Each merchant group (201) in the list (213) is identified to be associated with one or more active offers and include the merchant operating the transaction terminal (105) corresponding to the terminal information (209) of the transaction data (109).

In FIG. 9, the list (213) of merchant group (201) augments or enriches the transaction data (109) with merchant information that identifies merchant groups (201) that may be relevant to the offer processing of the payment transaction.

In FIG. 9, the rule engine (199) is configured to apply the offer rules (193) to the enriched transaction data (211), including the transaction data (109) from the transaction handler (103) and the list (213) of merchant groups (201) each containing the merchant that operates the transaction terminal (105) identified by the terminal information (209) provided in the transaction data (109).

During the application of the offer rules (193) to the enriched transaction data (211), the rule engine (199) may need additional offer related data (207), such as the location of the merchant, the location of the user (101), a balance of a reward benefits of the user (101), a current milestone status of an offer (186) towards benefit redemption, a purchase detail of the payment transaction, etc. The additional data can be added to the enriched transaction data (211) when needed.

In FIG. 9, since similar offers from different merchants and/or store locations are combined as a single offer, a single set of offer rules (193) can be evaluated by the rule engine (199) to process the enriched transaction data (211). The combined processing increases the efficiency of the rule engine (199) and avoids the need for the rule engine (199) to separate processing multiple sets of similar offer rules for different merchants and/or store locations identified in the list (213) of merchant groups (201).

Grouping/combining offers based on merchant hierarchy also simplifies the management of offers (186). For example, when a merchant or store location enters or leaves an offer campaign, the corresponding merchant group can be adjusted to include or exclude the merchant or store location. Thus, it is not necessary to add or remove a set of offer data for the merchant or store location.

In one embodiment, a computing apparatus in FIG. 9 implemented using at least one data processing system, as illustrated in FIG. 5, having at least one microprocessor (173) and memory (167) storing instructions configured to instruct the at least one microprocessor (173) to perform the operations described herein. The computing apparatus includes at least one of: the data warehouse (149), the transaction handler (103), the rule engine (199), and the transaction handler (103), each of which can be implemented using one or more data processing systems illustrated in FIG. 5. The data warehouse (149) is configured to store the offer rules (193), trigger records (197), the merchant hierarchy data illustrated in FIG. 9, and/or a portion or all of the offer related data (207).

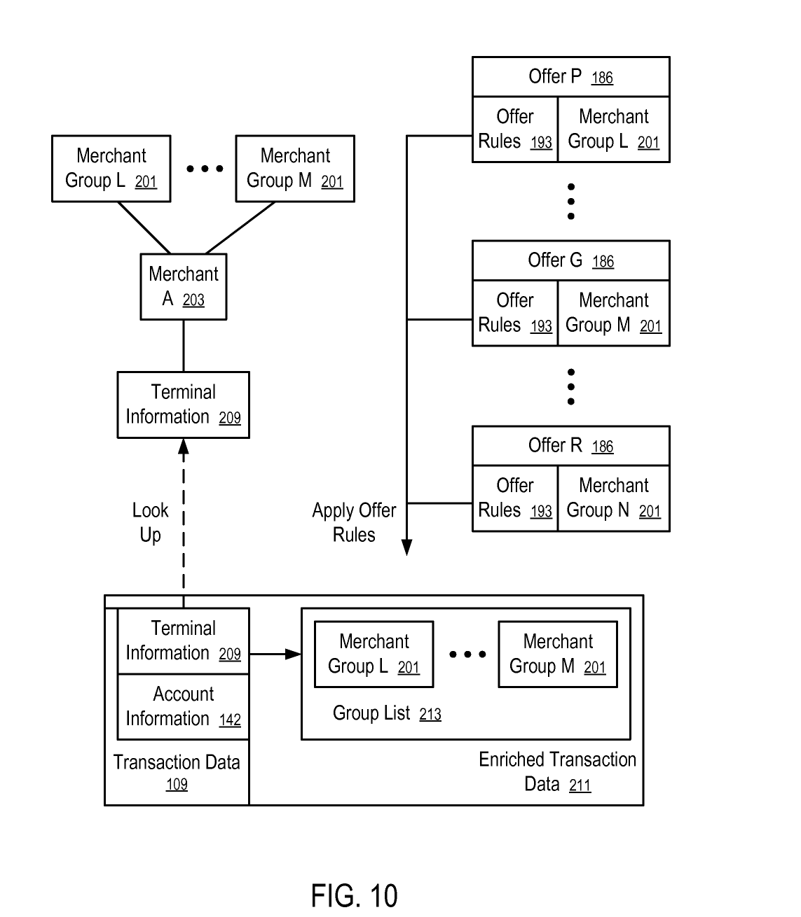

FIG. 10 shows a system configured to identify applicable offers based on a merchant hierarchy according to one embodiment. In FIG. 10, the enriched transaction data (211) of a payment transaction includes groups list (213) and the transaction data (109) of the payment transaction.

In one embodiment, the transaction data (109) includes data from a transaction request for the authorization or settlement of a payment in a payment processing network, such as terminal information (209) and account information (142) and other information such as transaction date and time, transaction amount, etc.

In one embodiment, the transaction data (109) includes the account information (142) that identifies the consumer account (146) using which the payment of the transaction is to be made.

In one embodiment, the transaction data (109) includes the terminal information (209) that identifies the transaction terminal (105) of a merchant A (203) on which the payment transaction is initiated. For example, the terminal information (209) of one embodiment includes a Card Acceptor ID (CAID), an acquirer bank identification number (Acquirer BIN), a terminal ID, etc. that can be used to identify whether or not the payment transaction is initiated for the merchant A (203).

In FIG. 10, the terminal information (209) in the transaction data (109) of a payment transaction is used to look up the identification of the merchant A (203) associated with the terminal information (209) and look up the identifications of the corresponding merchant groups (201) in which the merchant A (203) is a member. The information about the merchant groups (201) looked up using the terminal information (209) provided in the transaction data (109) is added as the group list (213) in the enriched transaction data (211).

In one embodiment, the data warehouse (149) stores the offer data including offers (186), where each of the offers (186) includes respective offer rules (193) and identifies the respective merchant group (201). The rule engine (199) is configured to apply the offer rules (193) to the enriched transaction data (211) to determine whether any of the offers (186) are applicable to the payment transaction.

In one embodiment, when the group list (213) in the enriched transaction data (211) does not include the respective merchant group (201) identified in a particular offer (186), the particular offer (186) is not applicable to the payment transaction corresponding to the enriched transaction data (211).

For example, in FIG. 10, the merchant group N (201) is not in the group list (213) specified in the enriched transaction data (211); and thus, the offer R (186) of the merchant group N (201) is not applicable to the payment transaction corresponding to the enriched transaction data (211).

For example, in FIG. 10, the merchant group P or G (201) is in the group list (213) specified in the enriched transaction data (211); and thus, the offer P or G (186) may be applicable to the payment transaction corresponding to the enriched transaction data (211); and the rule engine (199) is further configured to apply the other offer rules (193) of the offer P or G (186) to determine whether the offer P or G (186) is applicable to the payment transaction corresponding to the enriched transaction data (211).

Examples of other offer rules may include whether or not the payment transaction has a transaction amount above a threshold, whether or not the location of the transaction is within a predetermined geographical region, whether or not the time of the payment transaction is within a predetermined time period, etc.

In one embodiment, some of the merchant groups (201) may include only one merchant; and some of the merchant groups (201) may include a plurality of merchants. A merchant (203) may represent a store at a location separate from other merchants in the group. A merchant group (201) may correspond to a franchise, or a portion of a franchise. A merchant group (201) may be a set of merchants voluntarily to provide the same offer (186) (or similar offers that are combined, by the rule engine (199), as a unified offer (186) from the merchant group (201)). The merchants in a merchant group may or may not offer the same or similar products or services. The merchants in a merchant group may or may not be peer competitors.

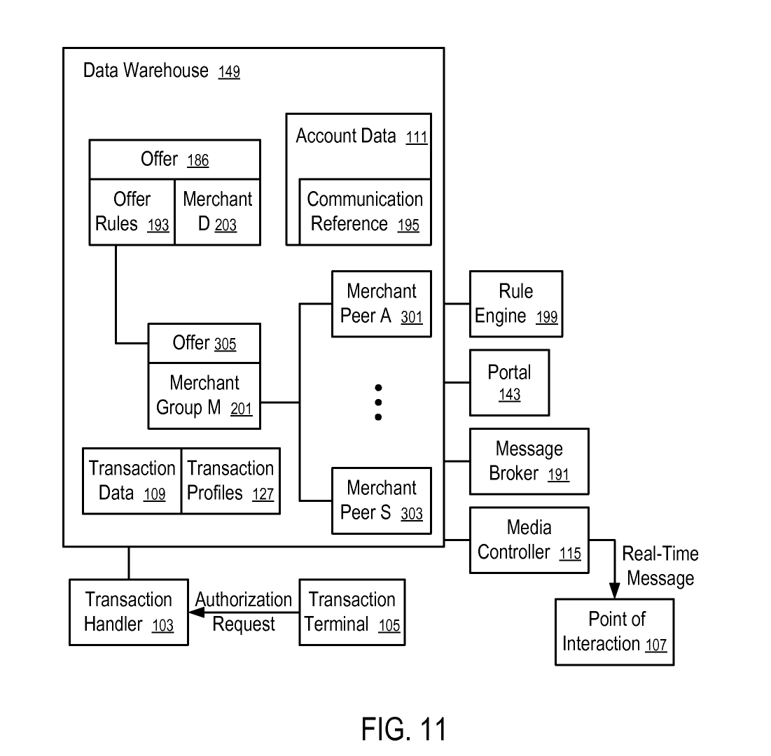

FIG. 11 shows a system configured to communicate offers to users according to one embodiment. In FIG. 11, the portal (143) is configured to receive the specification of an offer (186) from a merchant D (203), including the offer rules (193). The offer (186) is configured to provide a benefit, sponsored by the merchant D (203) or a third party, in response to a payment transaction between the merchant D (203) and a user (101) who has received the offer (186).

In FIG. 11, the offer (186) is to be provided to a user (101) in response to a payment transaction between the user (101) and a merchant in a merchant group M (201) that does not include the merchant D (203).

For example, the merchants (301, . . . , 303) in the merchant group (201) may be the peer competitors of the merchant D (203); and the merchant D (203) may want to send an offer (186) to the user (101) while the user (101) is purchasing from one of the peer competitors.

For example, the merchants (301, . . . , 303) in the merchant group (201) may provide products and services related to the business of the merchant D (203); and the merchant D (203) may want to send an offer (186) of complimentary or related products or services to the user (101) when the user is purchasing from a merchant in the merchant group (201).

For example, the rule engine (199) may identify, based on past transaction data (109) of various users, that a user making a purchase from a merchant in the merchant group M (201) is likely to be interested in the products or services of the merchant D (203); and based on such an analysis, the rule engine (199) may generate the offer (305) associated with the merchant group M (201) to arrange the delivery of the offer (186) of merchant D (203) to users, where the delivery of the offer (186) is in response to the payment transactions of the respective users with the merchants in the merchant group M (201).

In one embodiment, the merchant group (201) of the offer (305), configured for the delivery of the offer (186) of the merchant D (203), is identified by the rule engine (199) based on the transaction data (109) and/or transaction profiles (127) stored in the data warehouse.

In one embodiment, the merchant group (201) of the offer (305), configured for the delivery of the offer (186) of the merchant D (203), is identified based at least in part on the merchants registering to be part of the merchant group M (201), e.g., via a cooperative database discussed U.S. Pat. App. Pub. No. 2012/0066064, the disclosure of which is hereby incorporated herein by reference.

In one embodiment, the merchant group (201) of the offer (305), configured for the delivery of the offer (186) of the merchant D (203), is identified based at least in part on the merchants selected by the merchant D (203) for the offer (186).

In one embodiment, the merchant group (201) of the offer (305), configured for the delivery of the offer (186) of the merchant D (203), is identified via a combination of an analysis performed by the rule engine (199) using the transaction data (109) and/or the transaction profiles (127), the registration data of the merchants to be part the merchant group M (201), and/or the merchant D (203) selecting merchants from a set of candidates.

In FIG. 11, the offer (305) is configured for the transmission of the offer (186) to users who satisfies some of the requirements of the offer rules (193), in response to the payment transaction of the users with any of the merchants in the merchant group M (201).

For example, in response to an authorization request for a payment transaction of a user (101) from the transaction terminal (105) of a merchant (301, . . . , or 303) in the merchant group (201), the rule engine (199) is configured to obtain a set of enriched transaction data (211) that includes the merchant group M (201), e.g., in a way as illustrated in FIG. 10.

When the rule engine (199) determines that the payment transaction is from the merchant group N (201) of the offer (305), the rule engine (199) may further determine if the user (101) of the payment transaction is eligible for the offer (186), e.g., based on the transaction profile (127) of the user (101).

If the rule engine (199) determines that the user (101) is eligible for the offer (186), the rule engine (199) instructs the message broker (191) to generate a message providing the offer (186) to the user (101), and instructs the media controller (115) to transmit the message to the point of interaction (107) of the user (101) using the communication reference (195) stored in the data warehouse (149) in association with the account data (111) of the user (101).

For example, the point of interact (107) may be a mobile phone; and the message providing the offer (186) can be transmitted, via push notification, to the mobile phone at the communication reference (195) in real time with the processing of the authorization request from the transaction terminal (105).

In one embodiment, the offer (305) is generated by the rule engine (199) in response to the specification of the offer (186). In one embodiment, the offer (305) is a part of the offer (186). In one embodiment, the offer (305) is specified by a merchant using a user interface provided via the portal (143).

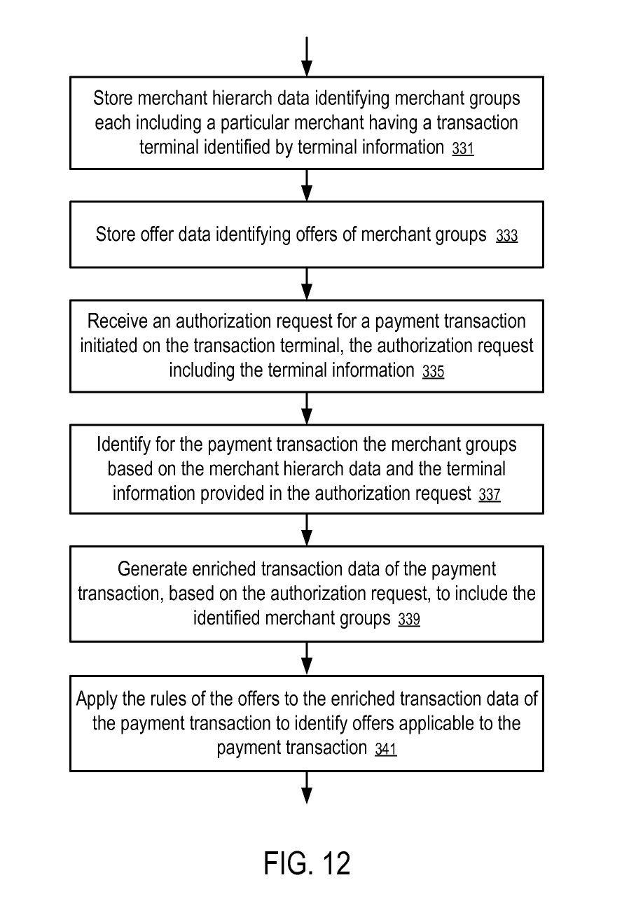

FIG. 12 shows a method of applying offer rules to identify offers applicable to a payment transaction according to one embodiment. For example, the method of FIG. 12 can be applied in a system illustrated in FIGS. 9, 10, and/or 11.

In FIG. 12, a computing apparatus is configured to store (331) merchant hierarchy data identifying merchant groups (201) each including a particular merchant having a transaction terminal (105) identified by terminal information (209); store (333) offer data identifying offers (186) of merchant groups (201); receive (335) an authorization request for a payment transaction initiated on the transaction terminal (105), where the authorization request including the terminal information (209); identify (337) for the payment transaction the merchant groups (201) based on the merchant hierarchy data and the terminal information (209) provided in the authorization request; generate (339) enriched transaction data (211) of the payment transaction, based on the authorization request, to include the identified merchant groups (201); and apply (341) the rules (193) of the offers (186) to the enriched transaction data (211) of the payment transaction to identify offers (186) applicable to the payment transaction.

For example, in one embodiment, the computing apparatus is configured to store merchant hierarchy data associating a plurality of transaction terminals with a plurality of merchants and associating the plurality of merchants with a plurality of merchant groups, in a way as illustrated in FIG. 8. Each transaction terminal in the plurality of transaction terminals is associated with a single merchant in the plurality of merchants; a first merchant in the plurality of merchants is associated with more than one merchant group in the plurality of merchant groups; and a first merchant group in the plurality of merchant groups has more than one merchant, including the first merchant.

The computing apparatus is further configured to store offer data associating a plurality of offers with the plurality of merchant groups, as illustrated in FIGS. 8 and 10. During processing of a payment transaction initiated on a first transaction terminal of the first merchant in a payment processing network, the computing apparatus identifies, using the merchant hierarchy data, the more than one merchant group, combines the transaction data (109) of the payment transaction with information about the more than one merchant group (213) to generate enriched transaction data (211), and apply rules (193) of the plurality of offers to the enriched transaction data to identify one or more offers that are applicable to the payment transaction.

For example, the computing apparatus is configured to identify the first merchant based on terminal information (209) of the first transaction terminal (105) identified in the payment transaction and a first portion of the merchant hierarchy data associating the plurality of transaction terminals with the plurality of merchants, and then identify the more than one merchant group for the payment transaction based on the first merchant identified via the payment transaction and a second portion of the merchant hierarchy data associating the plurality of merchants with a plurality of merchant groups.

In one embodiment, each of the plurality of offers (186) is associated with one or more merchant groups (201) in the plurality of merchant groups. In response to a merchant joining an offer associated with a merchant group, the computing apparatus adjusts the merchant hierarchy data to include the merchant in the merchant group of the offer without having to modify the offer data (including the offer rules of the offer), and without having to create a separate offer.

In response to the first merchant exiting an offer associated with a merchant group, the computing apparatus adjusts the merchant hierarchy data to remove the first merchant from the merchant group of the offer without having to modify the offer data, and without having to removing a complete offer.

In one embodiment, the computing apparatus is configured to combine a plurality of offers from a second plurality of merchants into a group offer, by generating a second merchant group to include the second plurality of merchants and associating the group offer with the second merchant group. If the combined offers have differences in offer rules, the computing apparatus is configured to implement the differences via offer rules added to the group offer.

In one embodiment, the first merchant group represents a franchise or a portion of the franchise; and each merchant in the first merchant group represents a different store in the franchise (or the portion of the franchise). In one embodiment, the first merchant group represents a peer group of merchants offering similar products or services.

In one embodiment, in response to a determination that a first offer is applicable to the payment transaction between the first merchant and a user, the computing apparatus is configured to transmit the first offer to the user to identify a benefit offered by a second merchant different from the first merchant, where the second merchant may not be in the first merchant group.

In one embodiment, the computing apparatus is configured to generate a group offer to target the provisioning of an offer from a particular merchant based on the transactions of a group of other merchants. For example, after receiving a first offer from the second merchant to provide a benefit to a user in response to a payment transaction between the user and the second merchant, the computing apparatus identifies the first merchant group, e.g., based on similarity in products or services provided by the second merchant and the first merchant group, and then generates a second offer for associating with the first merchant group, wherein the second offer is configured to communicate the first offer from the second merchant to the user in response to a payment transaction between the user and a merchant in the first merchant group.

The first merchant group may be identified based automatically by the computing apparatus based on transaction data of payment transactions processed in the payment processing network, or identified based at least in part on merchants enrolling in the first merchant group, or identified based at least in part on inputs received from the second merchant.

In one embodiment, the computing apparatus is configured to communicate the first offer to the user via push notification to a communication reference associated with a payment account of the user, in response to a payment transaction of the user made in the payment account with any merchant in the first merchant group.

In one embodiment, the computing apparatus includes at least one microprocessor; and memory storing instructions configured to instruct the at least one microprocessor to at least: store the merchant hierarchy data and the offer data; identify the more than one merchant group using the merchant hierarchy data during the processing of a payment transaction initiated on a first transaction terminal of the first merchant in a payment processing network; combine transaction data of the payment transaction with information about the more than one merchant group to generate enriched transaction data; and apply rules of the plurality of offers to the enriched transaction data to identify one or more offers applicable to the payment transaction.

In one embodiment, the memory includes a non-transitory computer storage medium storing the instructions configured for the computing apparatus.

In one embodiment, the computing apparatus includes at least one of: the data warehouse (149), the transaction handler (103), the rule engine (199), the portal (143), the message broker (191), and the media controller (115), each of which can be implemented using at least one data processing system illustrated in FIG. 5.

Some details about the system in one embodiment are provided in the sections entitled “CENTRALIZED DATA WAREHOUSE” and “HARDWARE.”

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

### Transaction Processing and Data

FIG. 2 shows a system to provide information and/or services based on transaction data (109) according to one embodiment.

In FIG. 2, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records, such as the transaction profiles (127), aggregated spending profile, offer redemption notification, etc. The portal (143) may be implemented as a web portal, a telephone gateway, a file/data server, etc.

In FIG. 2, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 2, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 2, the transaction handler (103) uses the data warehouse (149) to store the records about the transactions, such as the transaction records or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 2, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 2, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records, such as merchant category, transaction date, amount, etc. Examples and techniques in one embodiment are provided in U.S. Pat. App. Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. Pat. App. Pub. No. 2009/0048884, and entitled “Merchant Benchmarking Tool,” the disclosure of which application is hereby incorporated herein by reference.

### Transaction Terminal

FIG. 3 illustrates a transaction terminal according to one embodiment. The transaction terminal (105) illustrated in FIG. 3 can be used in various systems discussed in connection with other figures of the present disclosure. In FIG. 3, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 3. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 3. For example, in one embodiment, the transaction terminal (105) is an ATM machine, which includes components to dispense cash under certain conditions.

### Account Identification Device

FIG. 4 illustrates an account identifying device according to one embodiment. In FIG. 4, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 4, such as a cellular communications subsystem.

In one embodiment, the communication device (159) may access the account information (142) stored on the memory (167) without going through the processor (151).

In one embodiment, the account identification device (141) has fewer components than those illustrated in FIG. 4. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 5, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 5. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 5, with more or fewer components.

In one embodiment, the transaction handler (103) is a payment processing system, or a payment card processor, such as a card processor for credit cards, debit cards, etc.

FIG. 5 illustrates a data processing system according to one embodiment. While FIG. 5 illustrates various components of a computer system, it is not intended to represent any particular architecture or manner of interconnecting the components. One embodiment may use other systems that have fewer or more components than those shown in FIG. 5.

In FIG. 5, the data processing system (170) includes an inter-connect (171) (e.g., bus and system core logic), which interconnects a microprocessor(s) (173) and memory (167). The microprocessor (173) is coupled to cache memory (179) in the example of FIG. 5.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
storing, in a computing apparatus, merchant hierarchy data associating a plurality of transaction terminals with a plurality of merchants and associating the plurality of merchants with a plurality of merchant groups, wherein
each transaction terminal in the plurality of transaction terminals is associated with a single merchant in the plurality of merchants,
a first merchant in the plurality of merchants is associated with more than one merchant group in the plurality of merchant groups, and
a first merchant group in the plurality of merchant groups includes more than one merchant that includes the first merchant;
storing, in the computing apparatus, offer data associating a plurality of offers with the plurality of merchant groups;
during processing of a payment transaction initiated on a first transaction terminal of the first merchant in a payment processing network, identifying, by the computing apparatus using the merchant hierarchy data, the more than one merchant group;
combining, by the computing apparatus, transaction data of the payment transaction with information about the more than one merchant group to generate enriched transaction data; and
applying rules of the plurality of offers to the enriched transaction data to identify one or more offers applicable to the payment transaction.

2. The method of claim 1, further comprising:
identifying the first merchant based on terminal information of the first transaction terminal identified in the payment transaction and a first portion of the merchant hierarchy data associating the plurality of transaction terminals with the plurality of merchants;
wherein the more than one merchant group is identified for the payment transaction based on the first merchant identified via the payment transaction and a second portion of the merchant hierarchy data associating the plurality of merchants with a plurality of merchant groups.

3. The method of claim 2, wherein each of the plurality of offers is associated with one or more merchant groups in the plurality of merchant groups.

4. The method of claim 1, further comprising:
in response to a merchant joining an offer associated with a merchant group, adjusting the merchant hierarchy data without modifying the offer data.

5. The method of claim 4, wherein the offer data includes the offer rules.

6. The method of claim 1, further comprising:
in response to the first merchant exiting an offer associated with a merchant group, adjusting the merchant hierarchy data without modifying the offer data.

7. The method of claim 6, wherein the adjusting includes removing associating between the first merchant and the merchant group with which the offer is associated.

8. The method of claim 1, further comprising:
combining, by the computing apparatus, a plurality of offers from a second plurality of merchants into a group offer, by
generating a second merchant group to include the second plurality of merchants, and
associating the group offer with the second merchant group.

9. The method of claim 8, further comprising:
identifying, by the computing apparatus, differences in the plurality of offers; and
implementing, by the computing apparatus, the differences via offer rules for the group offer.

10. The method of claim 1, wherein the first merchant group represents a franchise; and each merchant in the first merchant group represents a different store in the franchise.

11. The method of claim 1, wherein the first merchant group represents a peer group of merchants offering similar products or services.

12. The method of claim 11, further comprising:
in response to a determination that a first offer is applicable to the payment transaction between the first merchant and a user, transmitting the first offer to the user to identify a benefit offered by a second merchant different from the first merchant.

13. The method of claim 12, wherein the second merchant is not included in the first merchant group.

14. The method of claim 1, further comprising:
receiving a first offer from the second merchant, the first offer configured to provide a benefit to a user in response to a payment transaction between the user and the second merchant;
identifying the first merchant group based on similarity in products or services provided by the second merchant and the first merchant group; and
generating a second offer for associating with the first merchant group, the second offer configured to communicate the first offer from the second merchant to the user in response to a payment transaction between the user and a merchant in the first merchant group.

15. The method of claim 14, wherein the first merchant group is identified based automatically by the computing apparatus based on transaction data of payment transactions processed in the payment processing network.

16. The method of claim 14, wherein the first merchant group is identified based at least in part on merchants enrolling in the first merchant group to provide permission for respective offers from respective merchants in the first merchant group to be triggered for transmission to users in response to payment transactions of the users with merchants that are in the first merchant group but different from respective merchants of the respective offers.

17. The method of claim 14, wherein the first merchant group is identified based at least in part on inputs received from the second merchant.

18. The method of claim 14, further comprising:
communicating the first offer to the user via push notification to a communication reference associated with a payment account of the user, in response to a payment transaction of the user made in the payment account with any merchant in the first merchant group.

19. A computing apparatus, comprising:
at least one microprocessor; and
memory storing instructions configured to instruct the at least one microprocessor to at least:
store, in the computing apparatus, merchant hierarchy data associating a plurality of transaction terminals with a plurality of merchants and associating the plurality of merchants with a plurality of merchant groups, wherein
each transaction terminal in the plurality of transaction terminals is associated with a single merchant in the plurality of merchants,
a first merchant in the plurality of merchants is associated with more than one merchant group in the plurality of merchant groups, and
a first merchant group in the plurality of merchant groups includes more than one merchant that includes the first merchant;
store, in the computing apparatus, offer data associating a plurality of offers with the plurality of merchant groups;
during processing of a payment transaction initiated on a first transaction terminal of the first merchant in a payment processing network, identify, by the computing apparatus using the merchant hierarchy data, the more than one merchant group;
combine, by the computing apparatus, transaction data of the payment transaction with information about the more than one merchant group to generate enriched transaction data; and
apply rules of the plurality of offers to the enriched transaction data to identify one or more offers applicable to the payment transaction.

20. A non-transitory computer storage medium storing instructions configured to instruct a computing apparatus to at least:
store, in the computing apparatus, merchant hierarchy data associating a plurality of transaction terminals with a plurality of merchants and associating the plurality of merchants with a plurality of merchant groups, wherein
each transaction terminal in the plurality of transaction terminals is associated with a single merchant in the plurality of merchants,
a first merchant in the plurality of merchants is associated with more than one merchant group in the plurality of merchant groups, and
a first merchant group in the plurality of merchant groups includes more than one merchant that includes the first merchant;
store, in the computing apparatus, offer data associating a plurality of offers with the plurality of merchant groups;
during processing of a payment transaction initiated on a first transaction terminal of the first merchant in a payment processing network, identify, by the computing apparatus using the merchant hierarchy data, the more than one merchant group;
combine, by the computing apparatus, transaction data of the payment transaction with information about the more than one merchant group to generate enriched transaction data; and
apply rules of the plurality of offers to the enriched transaction data to identify one or more offers applicable to the payment transaction.
